(19) United States
(12) Patent Application Publication
(10) Pub. No.: US 2016/0021025 A1
(43) Pub. Date: Jan. 21, 2016

(54) METHOD AND APPARATUS FOR NETWORK AND RESOURCE PREDICTION, IDENTIFICATION, AND AVAILABILITY

(71) Applicant: Motorola Solutions, Inc., Schaumburg, IL (US)

(72) Inventors: HEMANG F. PATEL, HOFFMAN ESTATES, IL (US); JAMES A. MAROCCHI, WINFIELD, IL (US); BRUNDABAN SAHOO, VERNON HILLS, IL (US)

(21) Appl. No.: 14/334,944

(22) Filed: Jul. 18, 2014

(51) Int. Cl. H04L 12/911; H04L 12/24; H04L 12/801

(52) U.S. Cl. CPC H04L 47/823; H04L 47/127; H04L 47/826; H04L 41/147; H04L 47/821; H04L 47/822

(57) ABSTRACT

A method, an infrastructure controller, and a network for network and resource prediction, identification, and availability include, given an incident at an incident area, predicting network resources needed at the incident based on a plurality of inputs; determining one or more networks at the incident and devices for accessing the one or more networks based on the predicted network resources and the plurality of inputs; and making the predicted network resources available on the one or more networks for the devices, wherein the devices are assigned to the one or more networks instead of making a local decision as to which of the one or more networks is accessed.

### BACKGROUND OF THE INVENTION

The present disclosure relates generally to wireless networking. At any given geographic location, various different wireless networks are available for mobile devices to access. As described herein, mobile devices can include, without limitation, subscriber units, user equipment, radios, smart phones, cell phones, tablets, access terminals, vehicle modems, etc. Conventionally, mobile devices, via middleware (e.g., a connection manager) and/or mobile virtual private networks (mVPNs), select a best available network. Although the mobile device is generally in the best position to make a decision for itself, placing the roaming decision entirely in the mobile device can lead to non-deterministic thrashing when large numbers of mobile devices are collocated (e.g., an incident). Some devices (e.g., vehicle modems) are better suited than others (e.g., portable mobile devices) to access certain networks (e.g., vehicle modems have higher power than portable mobile devices). For example, in a public safety application, a large number of mobile devices can be collocated with first responders (e.g., police officers, fire fighters, emergency medical technicians, etc., collectively referred to as first responders or public safety officers) at an incident. Moving forward, public safety devices have access to many different networks through multi-band, multimode, and multi-SIM (subscriber identity module) technologies (e.g., Public Safety (PS) Long Term Evolution (LTE), P25, TETRA, AT&T LTE, Sprint LTE, T-Mobile LTE, Verizon LTE, Television White Spaces (TVWS), 4.9 GHz, and the like).

With the non-deterministic thrashing associated with large numbers of collocated mobile devices, improper allocation between the many different networks can lead to congestion and an inability for some first responders to gain network access. Accordingly, there is a need for a method and apparatus for network and resource prediction, identification, and availability.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of an exemplary incident in accordance with some embodiments.

FIG. 2 is a flowchart of a method for network and resource prediction, identification, and availability in accordance with some embodiments.

FIG. 3 is a flowchart of a predicting method for the predicting step of the method of FIG. 2 in accordance with some embodiments.

FIG. 4 is a flowchart of a determination method for the determination step of the method of FIG. 2 in accordance with some embodiments.

FIG. 5 is a flowchart continuing the determination method of FIG. 4 in accordance with some embodiments.

FIG. 6 is a flowchart of a making method for the making step of the method FIG. 2 in accordance with some embodiments.

FIG. 7 is a flowchart of an incident identification/prediction method in accordance with some embodiments.

FIG. 8 is a block diagram of a controller which may be used as an infrastructure controller in accordance with some embodiments.

FIG. 9 is a block diagram of a mobile device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, a method for network and resource prediction, identification, and availability includes, given an incident at an incident area, predicting network resources needed at the incident based on a plurality of inputs; determining one or more networks at the incident, and one or more devices for accessing the one or more networks, based on the predicted network resources and the plurality of inputs; and making the predicted network resources available on the one or more networks for the devices, wherein the devices are assigned to the one or more networks instead of making a local decision as to which of the one or more networks is accessed.

In another exemplary embodiment, an infrastructure controller includes a network interface communicating with one or more networks; a processor communicating to the network interface; and memory storing instructions that, when executed, cause the processor to: given an incident at an incident area, predict network resources needed at the incident based on a plurality of inputs; determine one or more networks at the incident, and devices for accessing the one or more networks, based on the predicted network resources and the plurality of inputs; and make the predicted network resources available on the one or more networks for the devices, wherein the devices are assigned to the one or more networks instead of making a local decision as to which of the one or more networks is accessed.

In yet another exemplary embodiment, a system includes a private network; one or more commercial carrier networks; and an infrastructure controller communicatively coupled to the private network and the one or more commercial carrier networks, wherein the infrastructure controller comprises memory storing instructions that, when executed, cause a processor to: given an incident at an incident area, predict network resources needed at the incident based on a plurality of inputs; determine the one or more commercial carrier networks and the private network at the incident, and devices for accessing one or more of the one or more commercial carrier networks and the private network, based on the predicted network resources and the plurality of inputs; and make the predicted network resources available on the one or more commercial carrier networks and the private network for the devices, wherein the devices are assigned to the one or more commercial carrier networks and the private network instead of making a local decision as to which of the one or more commercial carrier networks and the private network is accessed.

In another exemplary embodiment, an infrastructure controller includes a network interface communicatively coupled to one or more networks; a processor communicatively coupled to the network interface; and memory storing instructions that, when executed, cause the processor to: given an incident at a geographic location, predict network resources needed at the incident based on a plurality of inputs; determine the one or more networks at the incident, and devices for accessing the one or more networks, based on the predicted network resources and the plurality of inputs; and make the predicted network resources available on the one or more networks for the devices, wherein the devices are assigned to the one or more networks instead of making a local decision as to which of the one or more networks is accessed.

In yet another exemplary embodiment, a network includes a private Long Term Evolution (LTE) network; one or more commercial carrier networks; and an infrastructure controller communicatively coupled to the private LTE network and the one or more commercial carrier networks, wherein the infrastructure controller comprises memory storing instructions that, when executed, cause a processor to: given an incident at a geographic location, predict network resources needed at the incident based on a plurality of inputs; determine which networks from among the private LTE network and the one or more commercial carrier networks to use at the incident and determine devices for accessing the determined networks based on the predicted network resources and the plurality of inputs; and make the predicted network resources available on the networks for the devices, wherein the devices are assigned to the determined networks instead of making a local decision as to which of the networks is accessed.

In various exemplary embodiments, a method and apparatus for network and resource prediction, identification, and availability provide a dynamic allocation of radio and network/infrastructure resources based on parameters, such as associated with a private network (e.g., FirstNet—www.firstnet.gov), and commercial operator policy and system loading factors for incident response scenarios. The method and apparatus can provide dynamic utilization of alternative communication functionality to enable reliable Public Safety mobile device connectivity for incident response. The method and apparatus can configure and execute policy for users across multiple network transports (Public Safety and commercial) for incident response situations and provide communication for Public Safety users when networks are congested. Generally, the method and apparatus assign a primary communication channel for PS users at an incident as well as preempting some users (e.g., moving such users to other networks) to ensure enough network/infrastructure resources are available based on predictions related to the incident.

The method and apparatus can perform device and machine utilization for the private network (e.g., FirstNet), such as prioritization of, and network admission for, Public Safety users/devices, and further can control interoperations of devices between Public Safety networks and commercial networks. The method and apparatus can provide utilization of alternative transport for reliable Public Safety communication, including deployment of temporary mobile networks for Public Safety coverage, device interactions with temporary mobile networks, etc. The method and apparatus can include incident occurrence and related communication, such as FirstNet and alternative network communication, for first responders, prioritization of users/devices related to incident response when communication networks are congested, etc.

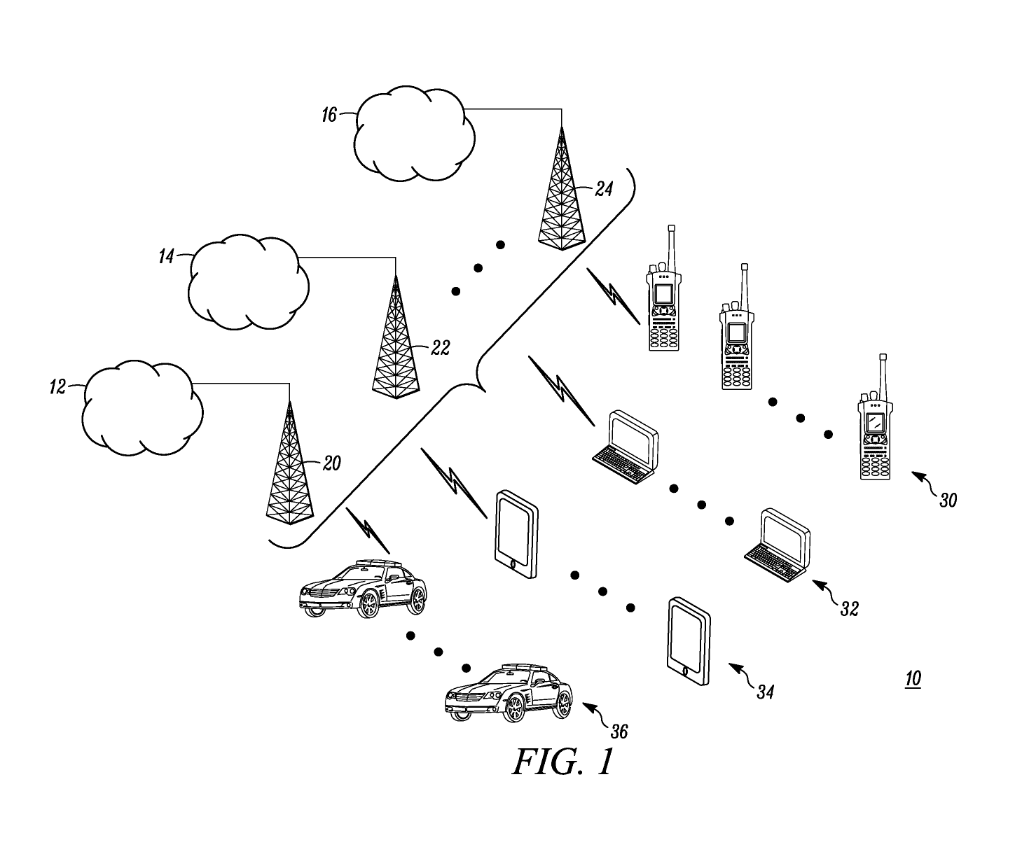

The present invention may be more fully described with reference to FIGS. 1-9. FIG. 1 is a block diagram of a system 10 that provides wireless services to an incident area, or scene, associated with an occurrence of an incident in accordance with some embodiments. In system 10, wireless access is available through a private network 12 and one or more commercial networks 14, 16 (two shown). The incident area is a geographic location where a plurality of users will need network access, such as from the networks 12, 14, and 16. Note, the wireless access can include additional networks as well which are omitted for illustration purposes. The networks 12, 14, 16 can include, without limitation, LTE, TV White Space (TVWS), fixed or mobile Public Safety (PS) services at 4.9 GHz, and the like. In an exemplary embodiment, the commercial networks 14, 16 can be networks operated by a commercial service provider, such as AT&T, Sprint, T-Mobile, Verizon, etc., although other commercial service providers are contemplated.

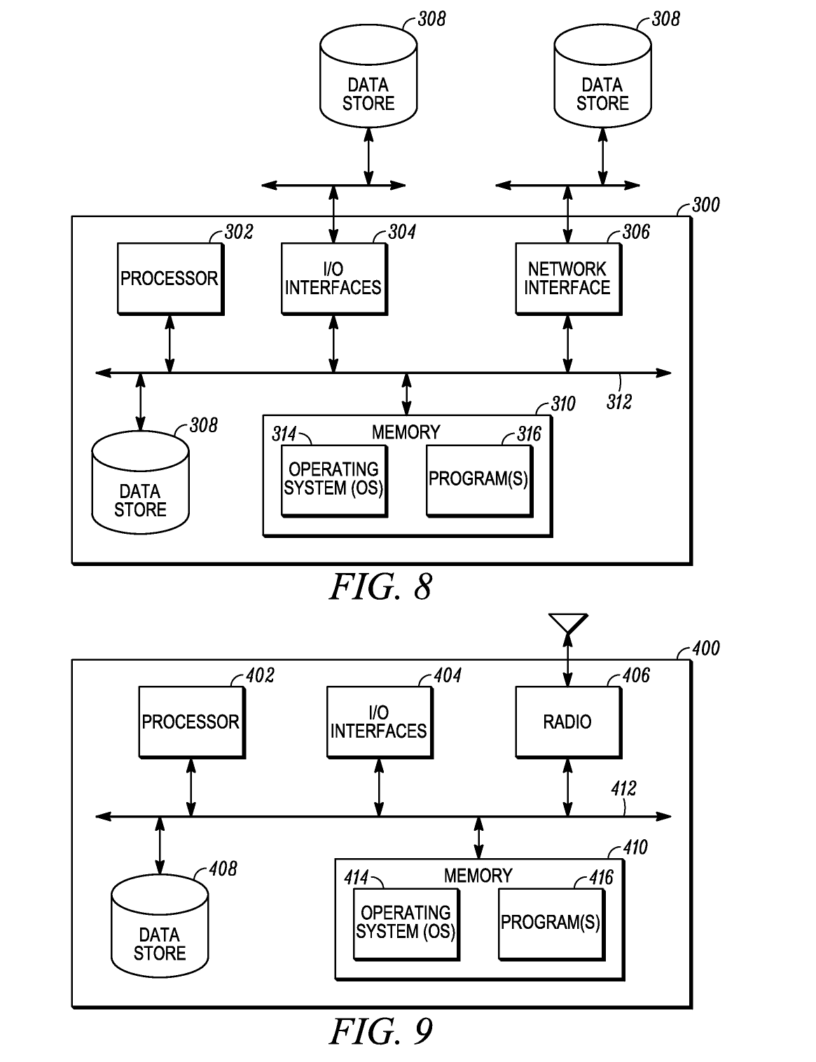

Access to the private, or PS, network 12 can be via a base station 20 (or multiple base stations 20). Access to the commercial networks 14, 16 can be via base stations 22, 24 (or multiple base stations 22, 24). In exemplary embodiments, when one or more of networks 12, 14, and 16 is an LTE network, the network's corresponding base station 20, 22, 24 can be an Evolved Node B (eNB). Variously, the base stations 20, 22, 24 and other equipment in the networks 12, 14, 16 can be referred to as an infrastructure, enabling users to engage in wireless communications, and the infrastructure can include an infrastructure controller (e.g., as depicted in FIG. 8) that is part of, or communicatively coupled to, the various base stations 20, 22, 24 for implementing the method and apparatus described herein.

The incident area includes a plurality of users and associated user devices 30, 32, 34, 36. For example, the devices 30 can include radios, smart phones, etc., the devices 32 can include wireless-enabled laptop computers, net-books, ultra-books, etc., the devices 34 can include wireless-enabled tablets, etc., and the devices 36 can include vehicle-based wireless modems (which can be connected to the other devices 30, 32, and 34). The devices 30, 32, 34, 36 are shown for illustration purposes, and those of ordinary skill in the art will recognize that any device configured to communicate with the networks 12, 14, 16 are contemplated. An exemplary configuration of the devices 30, 32, 34, 36 is described in FIG. 9. As described herein, there can be a large number of the devices 30, 32, 34, 36 at the incident, and conventionally, each of the devices 30, 32, 34, 36 makes its own local decision as to which of the networks 12, 14, 16 to connect to. The method and apparatus described herein seeks to make these decisions collectively, such as via the infrastructure controller, to ensure that all first responders can get appropriate network access.

Collectively, the networks 12, 14, 16 can provide network/infrastructure resources for the devices 30, 32, 34, 36. Specifically, one of the networks 12, 14, 16, such as the network 12, can be designated as a primary network providing primary network resources and the other networks 14, 16 can be designated as secondary networks providing secondary network resources. The method and apparatus for network and resource prediction, identification, and availability can include, given an incident at an incident area, predicting network resources needed at the incident based on a plurality of inputs; determining one or more networks at the incident, and devices for accessing the one or more networks, based on the predicted network resources and the plurality of inputs; and making the predicted network resources available on the one or more networks for the devices, wherein the devices are assigned to the one or more networks instead of making a local decision as to which of the one or more networks is accessed. The method and apparatus can include determining, from among one or more networks at the incident, a network to designate as a primary network to allocate primary network resources for use by incident responders and one or more networks to designate as secondary networks to allocate secondary network resources, wherein the secondary resources may be used, for example, for preemption of users, and thereby ensure that the predicted network resources are available for the incident responders on the primary network and the one or more secondary networks.

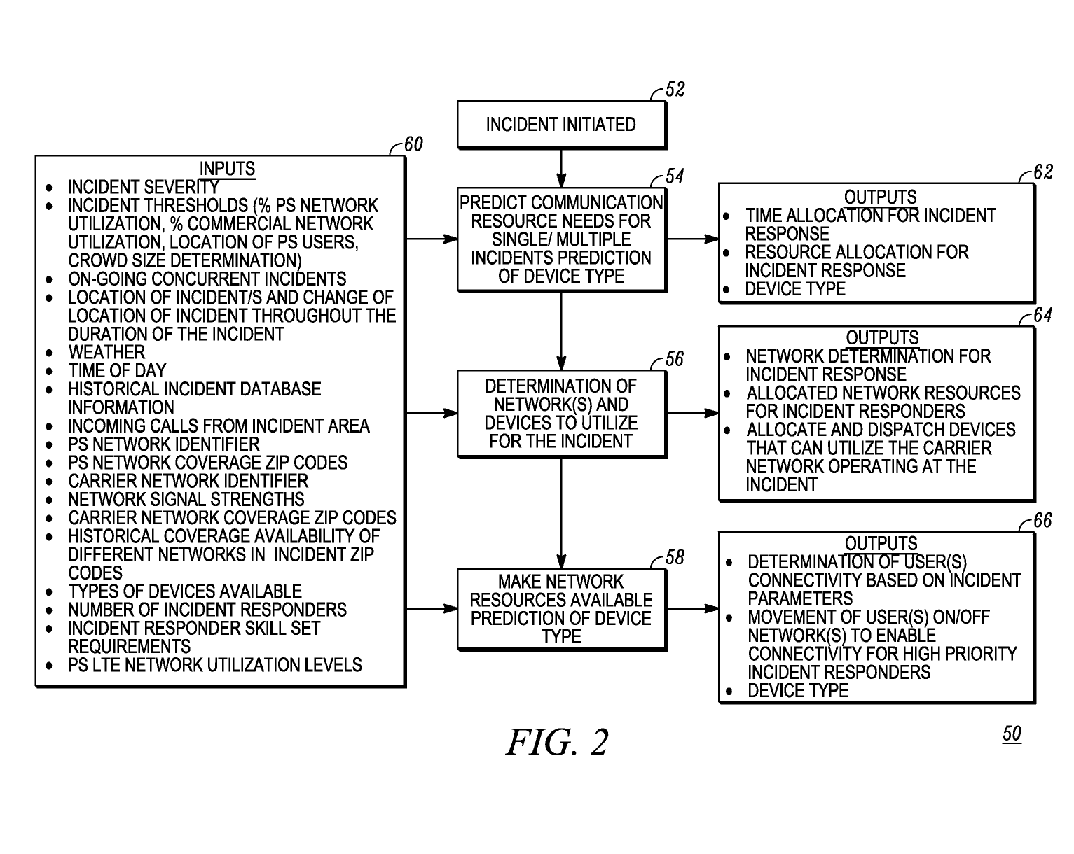

Referring now to FIG. 2, a flowchart is provided of a method 50 for network and resource prediction, identification, and availability in accordance with some embodiments. It is contemplated that method 50 may be performed in association with the incident depicted in FIG. 1 and may utilize the networks 12, 14, and 16. In an exemplary embodiment, the method 50 may be performed by an infrastructure controller, which infrastructure controller may be an infrastructure device that is communicatively coupled to the networks 12, 14, 16, or may be included in the base station 20 or in another element in the private network 12.

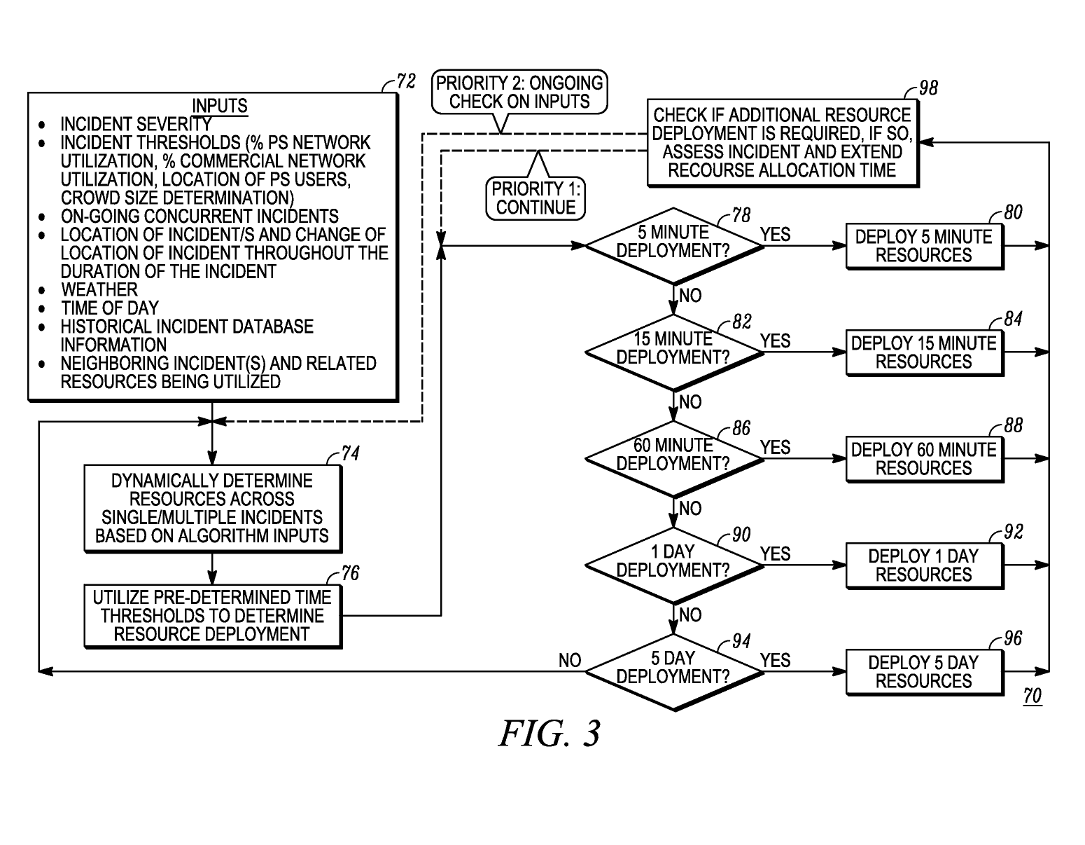

The method 50 starts when an incident is initiated (step 52). The incident occurs at a given geographic location, that is, the incident area. The method 50 includes three steps 54, 56, 58, which steps are elaborated in greater detail in FIGS. 3-6. Each of the steps 54, 56, 58 receives various inputs 60 and provides associated outputs 62, 64, 66.

The inputs 60 can include, without limitation:

Incident severity
Incident thresholds (% PS network utilization (e.g., the network 12), %
commercial/carrier network utilization (e.g., the networks 14, 16),
location of PS users, crowd size determination)
On-going Concurrent Incidents
Location of incident/s and change of location of incident throughout the
duration of the incident
Weather
Time of Day
Historical incident database information
Incoming calls from Incident area
PS network identifier
PS network coverage zip codes
Carrier network identifier
Network signal strengths
Carrier network coverage zip codes
Historical coverage availability of different networks in incident zip codes
Types of devices available
Number of incident responders
Incident responder skill set requirements
PS LTE network utilization levels
Device Type

The inputs 60 can be determined manually (based on user input) or automatically (based on data lookup, etc.), as well as a combination thereof. The manual inputs can include data from any public safety personnel, such as a dispatcher (e.g., Computer Aided Dispatch (CAD)), an incident commander, etc. The automatic inputs can be sourced by, or retrieved from, various applications and/or data sources (e.g., weather, time, coverage databases, mapping data, dispatch information, location information from first responders, etc.). The various inputs 60 enable the method 50 to optimize network usage between the private, for example, a public safety (PS), network 12 and the other networks 12, 14.

The method 50 includes predicting communication resource needs for single/multiple incidents (step 54). Here, the method 50 determines, for example, a number of responders assigned to an incident, a geographical size of the incident, an expected duration of the incident, expected data needs for the responders over the duration of the incident, and the like. The predicting step 54 further can be determined based on current and/or historical CAD data. Also, the predicting step 54 can include a consideration of a set of social media information (e.g., Facebook, Twitter) related to the incident, a combining of the social media information with network parameters (e.g., combining Twitter or Facebook information notifying that a given network is low or out of capacity, or that there is inadequate coverage at the incident, or that a specific QoS-type for applications needed for the incident response is not supported, and identifying the network capacity and coverage of alternative network(s) at the incident and determining a resource/device type to be dispatched to the incident based on network determination) across multiple heterogeneous networks, information about a group of users located in a certain geographical area, and CAD messages. Further, the predicting step 54 can utilize historical data to determine thresholds for parameters under consideration and to determine whether currently measured values for such parameters exceed the thresholds.

Referring now to FIG. 3, a flowchart is provided of a predicting method 70 that may be used to perform the predicting step 54 of the method 50 in accordance with some embodiments. The predicting method 70 includes inputs 72 which can include, without limitation:

Incident severity
Incident thresholds (% PS network utilization (e.g., the network 12), %
commercial/carrier network utilization (e.g., the networks 14, 16),
location of PS users, crowd size determination)
On-going Concurrent Incidents
Location of incident/s and change of location of incident throughout the
duration of the incident
Weather
Time of Day
Historical incident database information
Neighboring incident(s) and related resources being utilized

At step 74, the method 70 dynamically determines what resources are needed for an incident given the current situation and the expectations at the incident. More particularly, the method 70 dynamically determines, based on the algorithm inputs 72 (step 74), resources that will be needed by responders to the incident at incident area and/or by responders to or at other concurrent incidents. In making this determination, the method 70 may consider the private, e.g, PS, network 12 utilization, the commercial/carrier network (e.g., networks 14 and 16) utilization, and the location of PS users. Consideration of these factors may permit the method to make a crowd size determination, that is, to estimate a number of users that will desire to utilize the resources of networks 12, 14, and 16. For example, the method 70 can predict how many PS users will be at the incident, e.g., based on location information from each of the PS users, CAD inputs, etc., and estimate present and future demand for network resources. Further, the method 70 can look at on-going, concurrent incidents that may affect the utilization of networks 12, 14, and 16, as well as the locations of the incident(s) and predictions of changes of the incident locations throughout the duration of the incident(s). The method 70 can also look at other factors that may affect network utilization, such as weather (e.g., inclement weather may mean higher network utilization versus clear weather, etc.), time of day (e.g., higher network utilization during peak hours, etc.), and the like. The method 70 can use historical information, such as from a historical incident database, to determine a quantity of resources that were required by PS users at a similarly sized incident. Finally, the method 70 can look at neighboring incidents(s) and related resources being utilized to determine the resources available for the present incident.

In other words, at step 74, the current resource requirements may be known, based on feedback via the inputs 72, and an estimate of future resource requirements can be predicted based on how many PS users will be at the incident, their associated devices, and history based on similar incidents (e.g., a number of PS users that historically respond to an incident of similar type and severity). Thus, the method 70 is able to determine a resource allocation for an incident response. The resource allocation is a level of network resources needed to support all current/expected PS users at the incident. This can be, for example, expressed in a bandwidth amount.

Next, at step 76, the method 70 includes utilizes pre-determined time thresholds to determine, or select, a time estimate for resource deployment. That is, at step 76, the method 70 determines how long the resource allocation is needed. For example, steps 78-96 of the method 70 estimate how long the resource allocation is needed in pre-determined time thresholds, or blocks, such as, for example, a 5 minute deployment, a 15 minute deployment, a 60 minute deployment, a 1 day deployment, and a 5 day deployment. Of course, other amounts are also contemplated for the pre-determined time thresholds. A time allocation for incident response selected by the method 70 is based on an estimate of how long the PS users will be at the incident, which in turn may be estimated based on the inputs 72 and based on historical information associated with similar incidents (e.g., having similar inputs). Once the time allocation for incident response is selected in one of the various steps 78-96, the method 70 can continually, or periodically, check to see if additional resource deployment is required, and if so, assess incident and extend recourse allocation time (step 98). Here, the method 70 can, with a first priority, continue on with the selected time allocation for incident response and resource allocation for incident response, and, with a first priority return to the determining resources step 74 with updates to the inputs 72.

Returning to the method 50 in FIG. 2, following execution of the predicting step 54, the method has determined a time allocation for incident response and a resource allocation for incident response, i.e., how much bandwidth is needed and for how long. Next, at step 56, the method 50 determines network(s) and devices to utilize for responding to the incident. In determining the networks and devices to utilize, step 56 determines an expected throughput for the given incident location across all available networks. The networks include any accessible network at the incident location, e.g., the PS network 12, the networks 14, 16, etc. Throughput may be determined through coverage prediction and/or current or historical throughput measurements across all available networks at a given location. The throughput estimation also may take into account networks assigned to other, nearby incidents.

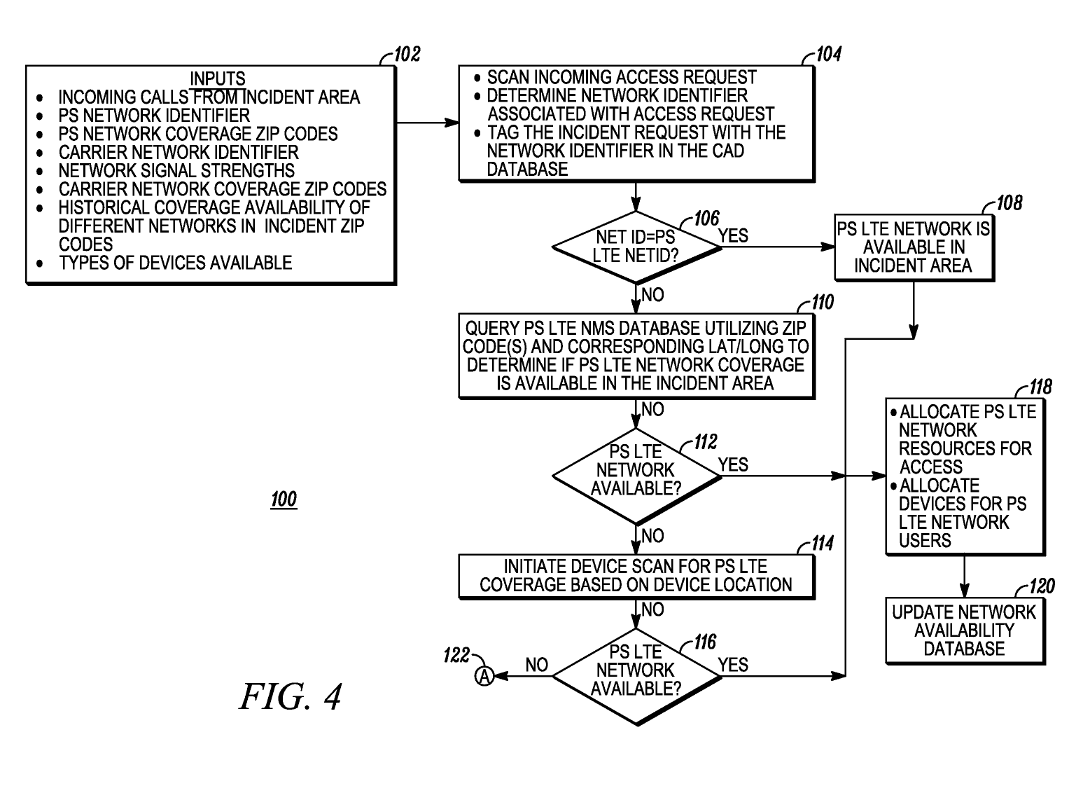

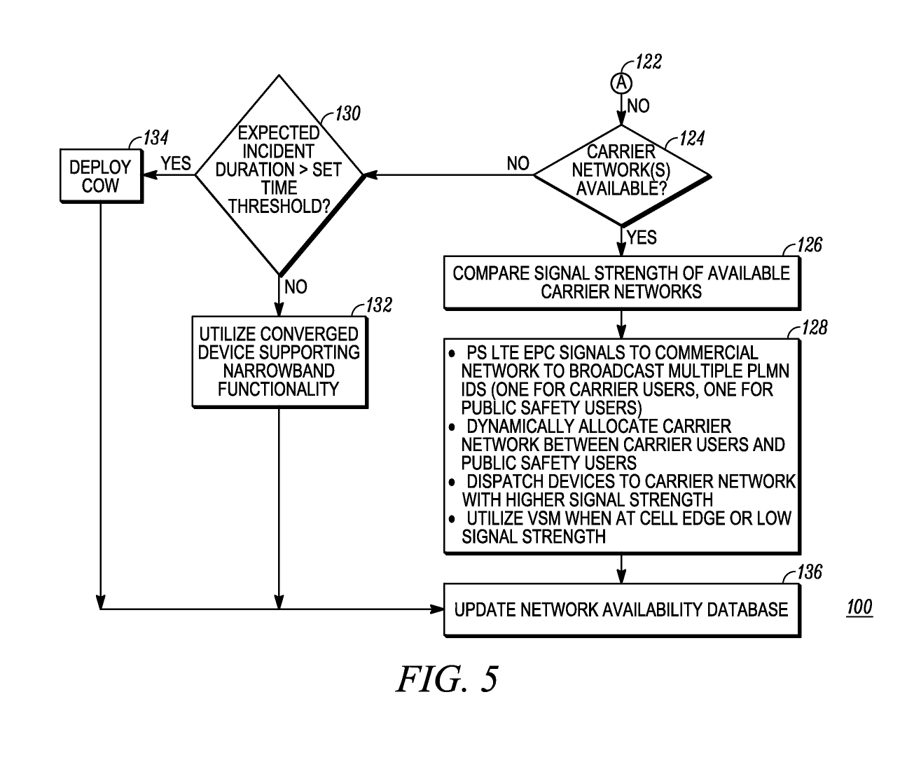

For example, FIGS. 4 and 5 are a flowchart of a determination method 100 that may be used to perform the determination step 56 of the method 50 in accordance with some embodiments. The determination method 100 includes inputs 102 which can include, without limitation:

Incoming calls from Incident area
PS network identifier
PS network coverage zip codes
Carrier network identifier
Network signal strengths
Carrier network coverage zip codes
Historical coverage availability of different networks in incident zip codes
Types of devices available

The method 100 is configured to make a network determination (i.e., to select one or more networks) for incident response, to determine allocated network resources for incident (i.e., public safety) responders, and to allocate and dispatch devices that can utilize a carrier network operating at the incident. This is based variously on the inputs 102, which generally relate to network coverage, network usage, and the like at the incident.

At step 104 of determination method 100, an incoming access request is scanned, a network identifier associated with the access request is determined, and the access request is associated, e.g., tagged, with the network identifier in a CAD database. In steps 106-116, the method 100 checks to see if there is a PS LTE network available at the incident. For example, the method 100 can check if the network identifier (Net ID) tagged to the access request is a network identifier for a PS LTE network (step 106). If so, then method 100 has determined (step 108) that there is the PS LTE network available in the incident area of system 10. If not (step 106), then method 100 can query (step 110) a PS LTE network management system (NMS) database utilizing zip code(s) and corresponding LAT/LONG to determine if PS LTE network coverage is available in the incident area of system 10. If so (step 112), then method 100 has determined that there is the PS LTE network available in the incident area of system 10. If not (step 112), then method 100 can initiate (step 114) a device scan for PS LTE coverage based on a location of the device sourcing the access request or any other device at the incident, i.e., the method 100 can check if a device at the incident has PS LTE coverage. If so (step 116), the method 100 has determined there is the PS LTE network at the incident area. In response to determining there is the PS LTE network at the incident area, the method 100 allocates (step 118) PS LTE network resources for access and allocates devices for PS LTE network users, and the method 100 updates (step 120) a network availability database, for example, maintained by, or in communication with, the infrastructure controller.

If the method 100 does not determine, at any of steps 108, 112, and 116, that there is a PS LTE network at the incident area, the method 100 proceeds to step 124 via step 122, as illustrated in FIG. 5. At step 124, the method 100 checks if there are any carrier network(s) (as opposed to private, or PS, networks) available at the incident. Again, the carrier network(s) can be commercial networks. If, at step 124, there are carrier network(s) available, the network 100 compares (step 126) signal strength of available carrier networks at the incident. Here, the method 100 is looking for the best carrier network (for example, in terms of local signal strength or any other well-known signal quality metric) to utilize for the incident responders. The method 100 can select the best carrier network. The method 100 then sends (step 128) PS LTE Evolved Packet Core (EPC) signals to the selected carrier network to broadcast multiple public land mobile network (PLMN) IDs (one for commercial, or carrier, users and one for the incident responders, that is, PS users), dynamically allocates the carrier network between carrier users and PS users, dispatches incident responders/PS users to the selected carrier network, and utilizes vehicle modems, such as a vehicular mobile mounted device (VML), when the PS users are at a cell edge or experiencing a low signal strength of the carrier network.

Thus, in the step 128, the method 100 is setting up the selected carrier network to handle the PS users. This includes broadcasting the PLMN IDs or other system identifiers so that the PS users can access the carrier network, as well as making strategic decisions for different devices. For example, if there is low signal strength (below a designated threshold), it may be impractical for mobile devices to use the carrier network whereas vehicle modems such as VMLs (which have higher transmit power levels) may fare better. That is, the device type (e.g., mobile, stationary, vehicle-mounted, etc.) can be considered in the selection of networks and infrastructure resources. Further, the commercial carrier networks can be dynamically partitioned, for example, between PS users and commercial, or carrier, users, to provide the PS users with dedicated bandwidth on the commercial carrier networks.

If, at step 124, there are no carrier network(s) available and if it is expected that the incident will have short time duration (e.g., shorter than an incident duration threshold, for example, shorter than 5 hours) (step 130), then the method 100 can utilize (step 132) a converged device with narrowband functionality (e.g., a PS narrowband network). Here, the method 100 can forgo network access and instead provide local communication (narrowband, i.e., voice) at the incident via a peer-to-peer or ad hoc arrangement. Finally, if, at step 124, there is no network support (PS LTE or carrier) and, at step 130, it is expected that the incident will have a long time duration (e.g., longer than an incident duration threshold, for example, longer than 5 hours), the method 100 can deploy (step 134) a cell-on-wheels (COW) solution (step 134). Finally, subsequent to the steps 128, 132, 134, at step 136 the method 100 can update the network availability database.

Returning to FIG. 2, following the execution of determination step 56, the method 50 has determined a time allocation for incident response and a resource allocation for incident response, i.e., how much bandwidth is needed and for how long, and has identified a network for utilization by the incident responders (e.g., the PS users), i.e., the PS LTE network, the carrier network, the COW, etc. Note that the identified network in the determination step 56 will be the incident responders primary network. In various embodiments, the identified network may be the PS LTE network, or may be the carrier network with its resources segmented, such that the identified network can support the estimated traffic for the estimated time based on the predicting step 54. At step 58, the method 100 then makes resources of the identified network available to the incident responders. The making step 58 includes outputs of a determination of user(s) connectivity based on incident parameters and movement of user(s) on/off network(s) to enable connectivity for the incident responders.

In making resources of the identified network available to the incident responders (step 58), the method 100 may provide for dynamic assignments and rerouting. For example, step 58 can include an assignment of networks to incidents based on existing network assignments to other incidents or generally based on overall traffic utilization. For example, if the PS LTE network is unavailable or overloaded in a given area (e.g., due to an incident or other event), neighboring incidents should be assigned to different carrier networks (e.g., incident A is assigned to use AT&T, incident B to Verizon, etc.) In this way, the method 50 affects ‘dynamic’ frequency reuse across incidents. The method 50 can also assign incident responders to an incident based on a compatibility of their equipment, such as their mobile devices, with the assigned network. For example, in low signal strength situations, vehicles with VMLs rather than, or in addition to, officers with portables can be sent to the incident. The VMLs (i.e., high power devices) may be able to operate where other, lower power, portable devices cannot and further may be able to provide hot spot offload or hot spot mode, thereby extending network coordinated coverage by providing a peer-to-peer network or alternative network offload mechanism. Further, the method 50 can assign devices (from the infrastructure) to specific networks. This removes the non-deterministic aspects described herein when network assignment is left to individual devices. The method 50 generally commands all devices assigned to an incident to use one or more particular networks, such as a PS LTE, AT&T, Verizon, T-Mobile, Sprint, and/or TVWS (assigned to a specific channel known to be non-interfering) network. Also, certain devices at an incident may be assigned to different networks if they are particularly high bandwidth or are associated with specialty responders (e.g., a helicopter). The method 50 can include identifying a set of dispatchable resources (i.e., wired or wireless resources that may be used for dispatch operations) that are compatible with the primary network resources and the secondary network resources available in the incident area; and configuring the set of dispatchable resources on a dynamic basis utilizing user and device priority.

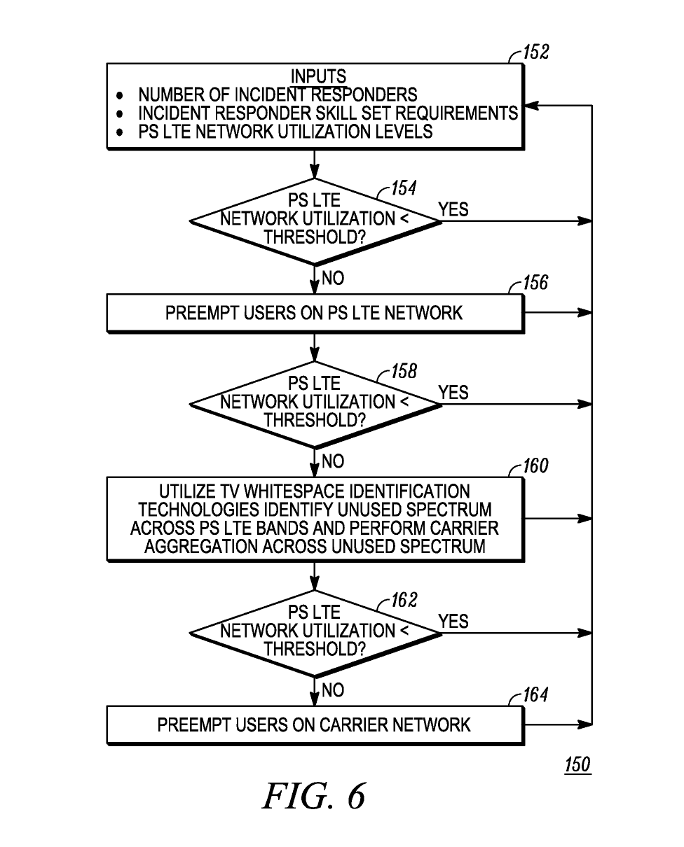

Referring now to FIG. 6, a flowchart is provided of a making method 150 that may be used to perform the making step 58 of the method 50 in accordance with some embodiments. The making method 150 includes inputs 152 which can include, without limitation:

Number of incident responders
Incident responder skill set requirements
PS LTE network utilization levels

In the embodiment depicted in FIG. 6, the making method 150 is described with reference to the identified network being the PS LTE network. However, those of ordinary skill in the art will recognize the making method 150 can also be used if a carrier network is selected instead. The overall objective of the making method 150 is to ensure there are enough network resources available for the PS devices at the incident.

At step 154 of method 150, the method checks if the PS LTE network utilization is below a threshold. If below the threshold, the making method 150 can return to the inputs 152 and check again later. If, at step 154, the PS LTE network utilization is above the threshold, i.e., over utilized, then the making method 150 can preempt (step 156) some devices on the PS LTE network (i.e., move the devices to a different, secondary network (wherein the PS LTE network is the primary network), such as a carrier network or TVWS spectrum). In preempting devices, the making method can identify and preempt low priority devices that are not assigned to the incident but are using the PS LTE network.

After preempting some devices, the making method 150 again checks (step 158) if the PS LTE network utilization is below the threshold. If so, the making method 150 can return to the inputs 152 and check again later. The low priority devices can also have network connectivity retries turned off. If, at step 158, the PS LTE network utilization is above the threshold, i.e., remains over utilized after preempting some users, the making method 150 can utilize (step 160) TV White Space (TVWS) identification technologies to identify unused spectrum across PS LTE bands and perform carrier aggregation across unused spectrum.

At step 162, the making method 150 again checks if the PS LTE network utilization is below the threshold after allocating TVWS (step 160). If so, the making method 150 can return to the inputs 152 and check again later. If, at step 162, the PS LTE network utilization is above the threshold, i.e., over utilized after allocating TVWS, the making method 150 can preempt (i.e., move) (step 164) some PS users to a carrier network. The method 150 then returns to the inputs 152 and checks again later. In this manner, the making method 150 can continually ensure there is enough bandwidth, i.e., that the PS LTE utilization is below the threshold such that all incident responders can receive service, or can preempt some of the PS users. The threshold can be based on the predicting step 54.

When making resources available to incident responders on a carrier network and determining whether sufficient resources are available, the making method 150 can, based on the estimate of resources required for the set time duration, continuously evaluate Private, or PS, LTE network utilization percentage for the set time duration or threshold (e.g., every 5, 10, 15 minutes) in the incident area. If the evaluation indicates that enough resources will be available for incident, or PS, users responding to single/multiple incidents, then no action is required; otherwise, the method 150 can preempt users from the network and free-up required resources on private network 12. The making method 150 further can perform carrier aggregation by utilizing unused spectrum and making more bandwidth available for the PS users who are on the carrier network by utilizing TVWS identification technologies. If there still are not adequate resources available on the carrier network, the making method 150 can extend the pre-emption/prioritization to carrier networks to make required network resources available.

In an exemplary embodiment, if all the PS users serving an incident area are assigned a higher priority based on their role, the method 50 can instruct certain users' capable devices to act as hot spots (master), for example, preempt the devices from performing other functionality if need be. Other devices (slave) then can connect to the master devices over Wi-Fi (e.g., IEEE 802.11 and variants thereof), thereby reducing network utilization. This can be referred to as Wi-Fi hot spot offload. For example, when the network utilization goes above a utilization threshold and low-priority PS users cannot be preempted (e.g., moved to another network), a remote dispatcher or the infrastructure controller (assuming it knows the capability of all devices in field) can instruct a certain number of devices to operate as hot-spots (master) and can direct some other devices (slave) to connect to a master device over Wi-Fi. Detection of the master devices by the slave devices can be performed in accordance with any of several well known ad-hoc network detection techniques, or the infrastructure controller can assign channels for peer-to-peer communications between the master and slave devices and inform the devices of the assigned channels.

The method and apparatus helps predict/update the network/communication/human resources required now and for a future incident duration with appropriate capabilities (e.g. priority, bandwidth, skill set) for the incident user group by combining the historical data and real time social information. This also helps to remotely identify the presence and signal strength of a PS LTE network and its availability in an incident area. Based on the signal strength of the PS LTE network and its availability, a dispatcher or infrastructure controller can dynamically drive the configuration of the devices to be operated in the incident area. This also helps allocate the network/communication/human resources required to respond to the incident with appropriate capabilities (e.g., bandwidth, priority, skillset) including preempting users on the carrier network, performing carrier aggregation utilizing white space technologies, preempting PS users on alternate PS networks or public carrier networks to free up resources for the public safety users in the incident area, and enhancing the resource pool by utilizing the resources identified from social media communication. For example, the method and apparatus can also identify and predict the incident in a novel way by utilizing, in real time, a set of social media information (e.g., Facebook, twitter), combining the social media information with network parameters across multiple heterogeneous networks, a group of users in a certain geographical location, and CAD messages, and performing historical data comparison for these parameters to determine whether they exceed set thresholds.

Advantageously, the method and apparatus maximize resource availability during incidents, optimize resource allocation and utilization for the predicted incident/duration for now and in future, predict the resource requirements for future for disaster preparedness, provide an efficient use of bandwidth, and can saves lives by performing earlier prediction.

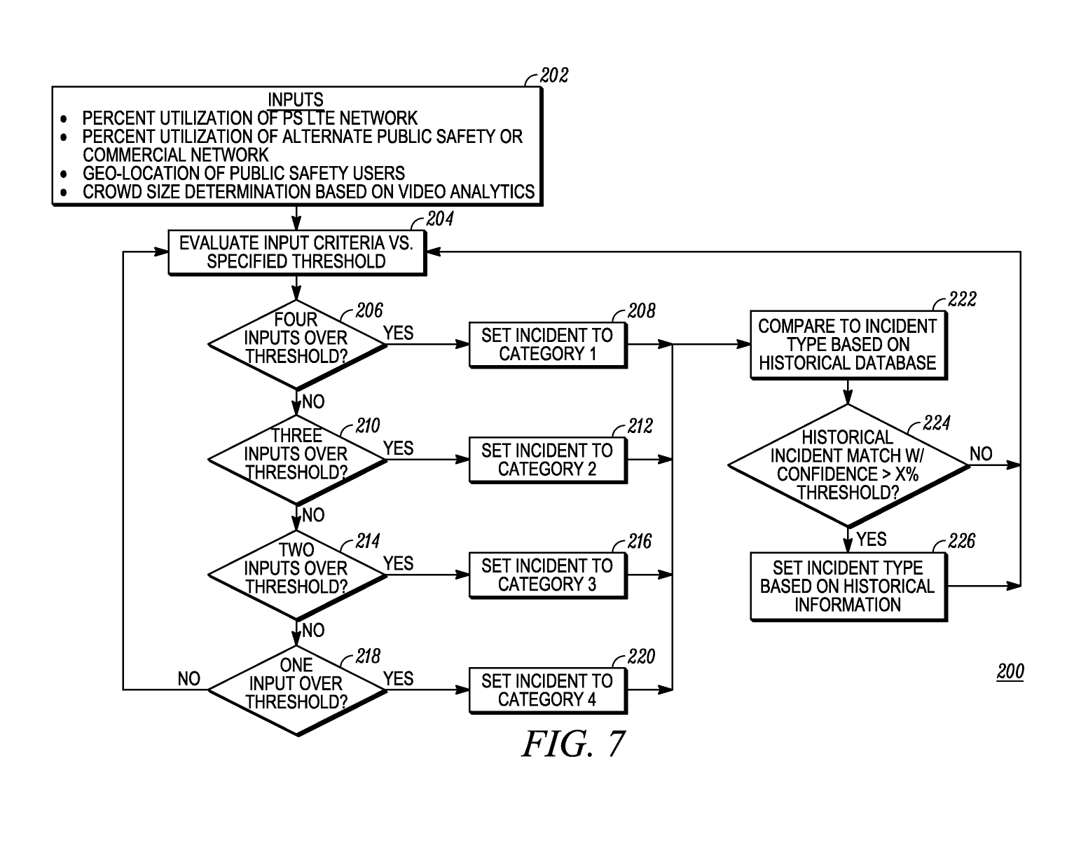

Referring now to FIG. 7, a flowchart of an incident identification/prediction method 200 is provided in accordance with some embodiments. The incident identification/prediction method 200 can be used in the predicting step 54 of the method 50 to categorize an incident. The incident identification/prediction method 200 includes input criteria 202 which can include, without limitation:

Percent utilization of PS LTE network
Percent utilization of alternate Public Safety or commercial network
Geo-location of Public Safety users
Crowd size determination based on video analytics

At step 204, the incident identification/prediction method 200 evaluates the input criteria 202 versus specific thresholds. For example, the input criteria 202 may be compared against the thresholds to determine a nature of the incident (from the perspective of setting up network resources in the method 50). Steps 206-220 then determine how many of the input criteria 202 are at or above their associated threshold and, based on the comparison of the input criteria 202 to their corresponding thresholds, the incident may be categorized into one of four categories. Of course, other input criteria can be used, the number of input criteria can be more or less than four, and more or less than four incident categories may be employed.

For example, if four parameters exceed their corresponding thresholds (step 206), then an incident may be categorized as a Category 1 (High Priority) incident (step 208). For example, suppose a Private (PS) LTE network throughput/utilization percentage exceeds a throughput/utilization threshold in a given geographic location, a utilization percentage of the Carrier network exceeds a Carrier network utilization threshold in the same geographic location, a group of public safety users located in the same geographic area exceeds a number of users threshold, and video analytics indicate a crowd size greater than a crowd size threshold. Then the incident may be categorized as a Category 1 (High Priority) incident (step 208). On the other hand, if only three of the parameters exceed their corresponding thresholds (step 210), then the incident may be categorized as a Category 2 (Medium Priority) incident (step 212). If only two conditions of the parameters exceed their corresponding thresholds (step 214), then the incident may be categorized as a Category 3 (Normal Priority) incident (step 216). And if only one of the parameters exceed its corresponding threshold (step 218), then the incident may be categorized as a Category 4 (Low Priority) incident (step 220). The incident identification/prediction method 200 can compare the above threshold conditions with past history and also categorize the type of incident (step 222). If there is a match with a historical incident with a certain confidence, e.g., which historical incident was above a certain threshold (step 224), then the incident identification/prediction method 200 can set the incident type for the current incident based on associated historical information of the match (step 226).

FIG. 8 is a block diagram of a controller 300 which may be used in the system 10 as an infrastructure controller in accordance with some embodiments. Specifically, the controller 300 can implement the various methods described herein. The controller 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 8 depicts the controller 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the controller 300, a semiconductor-based microprocessor (in the form of a microchip or chip set), or generally any device for executing software instructions. When the controller 300 is in operation, the processor 302 is configured to execute software stored within the memory 310, to communicate data to and from the memory 310, and to generally control operations of the controller 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the controller 300 to communicate on a network, such as the Internet, a wide area network (WAN), a local area network (LAN), and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network 100. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the controller 300 such as, for example, an internal hard drive connected to the local interface 312 in the controller 300. Additionally in another embodiment, the data store 308 may be located external to the controller 300 such as, for example, an external hard drive connected to the I/O interfaces 304 (e.g., SCSI or USB connection). In a further embodiment, the data store 308 may be connected to the controller 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

In an exemplary embodiment, the controller 300 can include instructions, i.e., through a program 316, that, when executed, causes the processor 302 to perform a method for network and resource prediction, identification, and availability. The method includes, given an incident at a geographic location, predicting network resources needed at the incident based on a plurality of inputs; determining one or more networks at the incident, and devices for accessing the one or more networks, based on the predicted network resources and the plurality of inputs; and making the predicted network resources available on the one or more networks for the devices, wherein the devices are assigned to the one or more networks instead of making a local decision as to which of the one or more networks is accessed. The method can further include predicting the network resources to provide a time allocation for incident response and a resource allocation for incident response based on the plurality of inputs.

The method can further include predicting the network resources based on current and historical Computer Aided Dispatch (CAD) information comprising any of a number of responders assigned to the incident, a size of the geographic location, an expected duration of the incident, and an expected data need at the incident. The method can further include determining the one or more networks at the incident to designate a primary network of the one or more networks for the predicted network resources and other networks of the one or more networks for preemption of users to ensure the predicted network resources are available on the primary network. The one or more networks comprise any of a private Long Term Evolution (LTE) network and one or more commercial carrier networks, and the method can further include designating some of the devices for use on the private LTE network and some of the devices for use on the one or more commercial carrier networks to ensure the predicted network resources are available; and causing broadcast of appropriate public land mobile network (PLMN) identifiers for the devices based on the designating.

The method can further include updating the designating over time to ensure the predicted network resources are available; and preempting some devices from the private LTE network required to ensure the predicted network resources are available. The method can further include implementing the designating considering device compatibility where vehicle modems are assigned to the one or more networks with lower signal strengths, mobile devices are assigned based on user priority, and the mobile devices configurable as hot spots are assigned accordingly. The determining the one or more networks can include identifying the one or more networks available at the geographic location; determining an expected throughput the incident across the one or more networks through any of coverage prediction, current measurements, and historical measurements; and accounting for other, nearby incidents to the geographic location in the determining the expected throughput.

The determining the one or more networks can include determining if a Public Safety Long Term Evolution (LTE) network is available at the geographic location, and if so, assigning the private LTE network as a primary network for the predicted network resources and dynamically preempting the devices as needed to ensure the predicted network resources are available. The preempting the devices can include any of assigning the devices with lower priority to a commercial carrier network; utilizing Television White Space identification to identify unused spectrum across Public Safety LTE bands and performing carrier aggregation across the unused spectrum; and enabling hot spot offload on some of the devices for Wi-Fi connectivity. The method can further include updating dispatch based on the predicting as to what capabilities are needed in the devices at the incident. The method can further include categorizing the incident based on the plurality of inputs; identifying matches of the incident in a historical database within a certain confidence; and utilizing information from the matches in the predicting.

FIG. 9 is a block diagram of a mobile device 400, which may be used in the system 10 or the like, in accordance with some embodiments. For example, the mobile device 400 can include, without limitation, a smart phone, a radio, a tablet, a vehicle modem, etc. As described herein, the mobile device 400 will get its network assignment based on the method 50, etc. instead of locally deciding. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 9 depicts the memory 410 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the memory 410, a semiconductor-based microprocessor (in the form of a microchip or chip set), or generally any device for executing software instructions. When the mobile device 400 is in operation, the processor 402 is configured to execute software stored within the memory 410, to communicate data to and from the memory 410, and to generally control operations of the mobile device 400 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the memory 410. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); Land Mobile Radio (LMR); Digital Mobile Radio (DMR); Terrestrial Trunked Radio (TETRA); Project 25 (P25); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 9, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with the network 100.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for network and resource prediction, identification, and availability, the method comprising:
given an incident at an incident area, predicting network/infrastructure resources and device type needed at the incident based on a plurality of inputs;
determining one or more networks and associated infrastructure resources at the incident, and devices for accessing the one or more networks, based on the predicted network/infrastructure resources and the plurality of inputs; and
assigning the predicted network/infrastructure resources available on the one or more networks for the devices, wherein the devices are assigned to the one or more networks instead of making a local decision as to which of the one or more networks is accessed.

2. The method of claim 1, further comprising:
predicting the network resources to provide a time allocation for incident response and a resource allocation for incident response based on the plurality of inputs.

3. The method of claim 1, further comprising:
predicting the network/infrastructure resources based on current Computer-Aided Dispatch information comprising any of a number of responders assigned to the incident, a size of the incident area, an expected duration of the incident, type of incident, and an expected data needed at the incident.

4. The method of claim 1, further comprising:
predicting the network/infrastructure resources based on current Computer-Aided Dispatch information comprising any of a number of responders assigned to a group of neighboring incidents, size of areas of the group of neighboring incidents, expected duration of all the group of neighboring incidents, type the group of neighboring incidents, and expected data needed at all of the group of neighboring incidents.

5. The method of claim 1, further comprising:
determining among one or more networks at the incident to designate a primary network to allocate primary network resources with a highest likelihood of resource availability and one or more secondary networks to allocate secondary network resources for preemption of users to ensure the predicted network/infrastructure resources are available on the primary network and the one or more secondary networks.

6. The method of claim 5, further comprising:
identifying a set of dispatchable resources that are compatible with the primary network resources and the secondary network resources available in the incident area; and
configuring the set of dispatchable resources on a dynamic basis utilizing user and device priority.

7. The method of claim 5, further comprising:
preempting the devices through any steps of:
preempting and assigning the devices with lower priority to the secondary network resources; and
enabling hot spot, peer to peer, or alternative network offload mechanism on some of the devices.
direct low priority devices to turn off network connectivity retries to the primary network for a set time threshold.

8. The method of claim 5, further comprising:
selecting and dispatching high power devices to the incident area where a network coordinated coverage of the primary network or the secondary network is below a designated threshold; and
configuring the high power devices in a hot spot mode to extend the network coordinated coverage.

9. The method of claim 1, wherein the one or more networks comprise any of a private network and one or more commercial carrier networks, and the method further comprising:
designating some of the devices for use on the private network and some of the devices for use on the one or more commercial carrier networks to ensure the predicted network/infrastructure resources are available; and
causing broadcast of multiple public land mobile network (PLMN) identifiers or system identifiers comprising one for commercial carrier network and one for private network where the one or more commercial carrier networks are dynamically partitioned to provide the Public Safety customers dedicated bandwidth on the one or more carrier networks.

10. The method of claim 9, further comprising:
updating the predicted network resources available for an extended duration of the incident; and
preempting some devices from the private network and the one or more commercial carrier networks to ensure the predicted network/infrastructure resources are available.

11. The method of claim 9, further comprising:
dynamically utilizing an available Television White Space (TVWS) spectrum on some of the devices, wherein the some of the devices are configured by the network to utilize the TVWS for network access or perform dynamic carrier aggregation between the TVWS and the private network.

12. The method of claim 9, further comprising:
assigning the devices to the private network or the one or more carrier networks or, public safety narrowband networks based on associated device capability and the respective network availability.

13. The method of claim 1, further comprising determining the one or more networks through steps of:
identifying the one or more networks available at the incident area;
determining an expected throughput across the one or more networks at the incident area through any of coverage prediction, current measurements, and historical measurements;
accounting for other, nearby incidents to the incident area in determining the expected throughput; and
assigning the devices to the one or more networks based on a plurality of inputs corresponding to current incident and neighboring incidents.

14. The method of claim 1, further comprising determining the one or more networks through steps of:
determining if a private network is available at the incident area, and if so, assigning the private network as a primary network for the predicted network/infrastructure resources and dynamically preempting the devices as needed to ensure the predicted network/infrastructure resources are available.

15. An infrastructure controller, comprising:
a network interface communicating with one or more networks;
a processor communicating to the network interface; and
memory storing instructions that, when executed, cause the processor to:
given an incident at an incident area, predict network resources needed at the incident based on a plurality of inputs;
determine one or more networks at the incident, and devices for accessing the one or more networks, based on the predicted network resources and the plurality of inputs; and
make the predicted network resources available on the one or more networks for the devices, wherein the devices are assigned to the one or more networks instead of making a local decision as to which of the one or more networks is accessed.

16. The infrastructure controller of claim 15, wherein the instructions that, when executed, further cause the processor to:
predict the network resources based on current Computer-Aided Dispatch information comprising any of a number of responders assigned to the incident, a size of the incident area, an expected duration of the incident, type of incident, and an expected data need at the incident.

17. The infrastructure controller of claim 15, wherein the instructions that, when executed, further cause the processor to:
determine among one or more networks at the incident to designate a primary network to allocate primary network resources and one or more secondary networks to allocate secondary network resources for preemption of users to ensure the predicted network resources are available on the primary network and the one or more secondary networks.

18. The infrastructure controller of claim 15, wherein the one or more networks comprise any of a private network and one or more commercial carrier networks, and wherein the instructions that, when executed, further cause the processor to:
designate some of the devices for use on the private network and some of the devices for use on the one or more commercial carrier networks to ensure the predicted network resources are available; and
cause broadcast of multiple public land mobile network (PLMN) identifiers or system identifier comprising one for commercial carrier networks and one for private network where the one or more commercial carrier networks are dynamically partitioned to provide the Public Safety customers dedicated bandwidth on the one or more commercial carrier networks.

19. The infrastructure controller of claim 15, wherein the instructions that, when executed, further cause the processor to:
identify the one or more networks available at the incident area;
determine an expected throughput the incident across the one or more networks through any of coverage prediction, current measurements, and historical measurements;
account for other, nearby incidents to the incident area in the determining the expected throughput; and
assign the devices to the one or more networks based on a plurality of inputs corresponding to current incident and the neighboring incidents.

20. A system, comprising:
a plurality of networks comprising a private network and one or more commercial carrier networks;
an infrastructure controller communicatively coupled to the private network and the one or more commercial carrier networks, wherein the infrastructure controller comprises memory storing instructions that, when executed, cause a processor to:
given an incident at an incident area, predict network resources needed at the incident based on a plurality of inputs;
determine the one or more commercial carrier networks and the private network at the incident, and one or more devices for accessing the determined networks, based on the predicted network resources and the plurality of inputs; and
make the predicted network resources available on the determined networks for the devices, wherein the devices are assigned to the one or more commercial carrier networks and the private network instead of making a local decision as to which of the one or more commercial carrier networks and the private network is accessed.
